(19) United States
(12) Patent Application Publication
(10) Pub. No.: US 2024/0360951 A1
(43) Pub. Date: Oct. 31, 2024

(54) RACK IN RACK FOR COMPUTERS

(71) Applicant: Cheng Yu Huang, New Taipei City (TW)

(72) Inventor: Cheng Yu Huang, New Taipei City (TW)

(21) Appl. No.: 18/142,653

(22) Filed: May 3, 2023

(30) Foreign Application Priority Data
Apr. 28, 2023 (TW) 112204144

(51) Int. Cl. F16M 11/38; F16M 11/20

(52) U.S. Cl. CPC F16M 11/38; F16M 11/2021

(57) ABSTRACT

A rack apparatus includes a mother rack including a rectangular platform member, a pivotal left L-shaped support, a pivotal right L-shaped support, a left groove on the platform member, a right groove on the platform member, and a space under the platform member; and a daughter rack including a rectangular platform element, a pivotal left leg, a pivotal right leg, a pivotal limit member disposed on a front end of the platform element, a pivotal surface disposed rearward of the pivotal limit member, a rear support leg having two ends pivotably secured to a back surface of the pivotal surface and the platform element respectively, and a space under the platform element. The left leg may be fastened in the left groove and the right leg may be fastened in the right groove respectively.

### FIELD OF THE INVENTION

The invention relates to racks and more particularly to a rack apparatus comprising a mother rack and a daughter rack so that for example, two computer displays may be placed the mother rack and the daughter rack respectively in a first configuration, a computer display may be placed on the mother rack and a laptop computer may be placed on the daughter rack respectively in a second configuration.

### BACKGROUND OF THE INVENTION

Computer, communication, and consumer electronics (3C) are popular throughout the world and they are characterized by short popular life. Thus, many enterprises invest great resources in the research and development of 3C products.

Many people own at least one of a personal computer (PC), a laptop computer, a tablet computer, and a mobile phone such as smart phone. Modern smart phones have many functions similar to a PC and thus are multifunctional.

As for PCs, they are typically used in home or office due to stable power, quality screen, large keyboard, mouse, high capacity memory, etc. Typically a PC comprises a monitor, a keyboard, and a mouse.

As for mobile phones, tablet computers and laptop computers, they are light weight and portable. Thus, frequent charging is inevitable for their use. Further, how to support them and properly connect them is a big issue to be addressed. It is necessary to take holding above electronic devices in place into consideration when using them in an indoor environment. Sufficient space for accommodating them is also an issue to be addressed especially when the space is limited.

Further, it is often that a number of PCs, laptop computers, tablet computers and displays are placed on a table. Thus, how to orderly place them on the table without being messy is another issue to be addressed.

U.S. Pat. No. 10,251,477B1 to Huang discloses a detachable, multifunctional rack for electronic devices includes a rectangular platform including a lower board secured to an underside, two sets of a plurality of hollow members on two sides of the lower board respectively, and a space under the lower board; two L-shaped supports mounted to two sides of the platform respectively, each support including a horizontal member releasably secured to either side of the platform, a vertical member releasably secured to the horizontal member, and a plurality of aligned, spaced tubular members on one side of the horizontal member; and two pins each passing through one set of the hollow members and the tubular members at either side of the platform to fasten the platform and the supports together.

While the device enjoys its success in the market, continuing improvements in the exploitation of rack of this type are constantly sought.

### SUMMARY OF THE INVENTION

It is therefore one object of the invention to provide a rack apparatus, comprising a mother rack including a rectangular platform member on a top, a left L-shaped support pivotably secured to a left side of the platform member, a right L-shaped support pivotably secured to a right side of the platform member, a left groove disposed on a left side of the platform member, a right groove disposed on a right side of the platform member, and a space member disposed under the platform member; and a daughter rack including a rectangular platform element on a top, a left leg pivotably secured to a left side of the platform element, a right leg pivotably secured to a right side of the platform element, a pivotal limit member disposed on a front end of the platform element, a pivotal surface disposed rearward of the pivotal limit member, a rear support leg having a first end pivotably secured to a back surface of the pivotal surface and a second end pivotably secured to the platform element, and a space element under the platform element; wherein the left leg is configured to fasten in the left groove and the right leg is configured to fasten in the right groove respectively.

The above and other objects, features and advantages of the invention will become apparent from the following detailed description taken with the accompanying drawings

### BRIEF DESCRIPTION OF THE DRAWINGS

FIG. 1 is a perspective view of a mother rack of a rack apparatus for computers of the invention, two L-shaped supports being folded;

FIG. 2 is a view similar to FIG. 1 where the L-shaped supports are unfolded to be ready to use;

FIG. 3 is a perspective view of the mother rack where the supports are unfolded, a computer display is placed on a platform of the mother rack, and a tablet computer is about to dispose under the platform;

FIG. 4 is a perspective view of the mother rack where the supports are unfolded and a laptop computer is placed on the platform of the mother rack;

FIG. 5 is a perspective view of a daughter rack of the rack apparatus for computers, the legs being folded;

FIG. 6 is a perspective view of the daughter rack where a pivotal limit member is fully pivoted to be substantially perpendicular to a platform of the daughter rack, a pivotal surface is pivoted to an inclined angle, and a laptop computer is placed on the pivotal surface and stopped by the pivotal limit member in a use state;

FIG. 7 is a side elevation of the daughter rack where the pivotal limit member is fully pivoted to be substantially perpendicular to the platform of the daughter rack, the pivotal surface is pivoted to an inclined angle, and two legs are unfolded in another ready to use state;

FIG. 8 is a perspective view of the daughter rack where the pivotal limit member is pivoted to lie on the platform of the daughter rack, the pivotal surface is pivoted to lie on the platform of the daughter rack, and the legs are unfolded in another ready to use state;

FIG. 9 is a view similar to FIG. 8 where a computer display is placed on the platform of the daughter rack;

FIG. 10 is a perspective view of the daughter rack where the pivotal limit member is fully pivoted to be substantially perpendicular to the platform of the daughter rack, the pivotal surface is pivoted to an inclined angle, the legs are unfolded, a laptop computer is placed on the pivotal surface and stopped by the pivotal limit member, and a tablet computer is about to dispose under the platform of the daughter rack in another use state;

FIG. 11 is a perspective view showing the daughter rack to be disposed under the platform of the mother rack;

FIG. 12 is a perspective view showing the daughter rack has been disposed under the platform of the mother rack;

FIG. 13 is a perspective view showing a computer display placed on the platform of the mother rack and another computer display placed on the platform of the daughter rack;

FIG. 14 is a perspective view showing a computer display placed on the mother rack and a laptop computer is placed on the daughter rack;

FIG. 15 is a perspective view showing the daughter rack placed on the mother rack which has the L-shaped supports folded;

FIG. 16 is a view similar to FIG. 15 where the L-shaped supports of the mother rack are unfolded;

FIG. 17 is a view similar to FIG. 16 where a computer display is placed on the platform of the daughter rack, a tablet computer is about to dispose in the daughter rack, and a computer keyboard is about to dispose in the mother rack; and

FIG. 18 is a view similar to FIG. 17 where a laptop computer is placed on the daughter rack, a tablet computer is about to dispose in the daughter rack, and a computer keyboard is about to dispose in the mother rack.

### DETAILED DESCRIPTION OF THE INVENTION

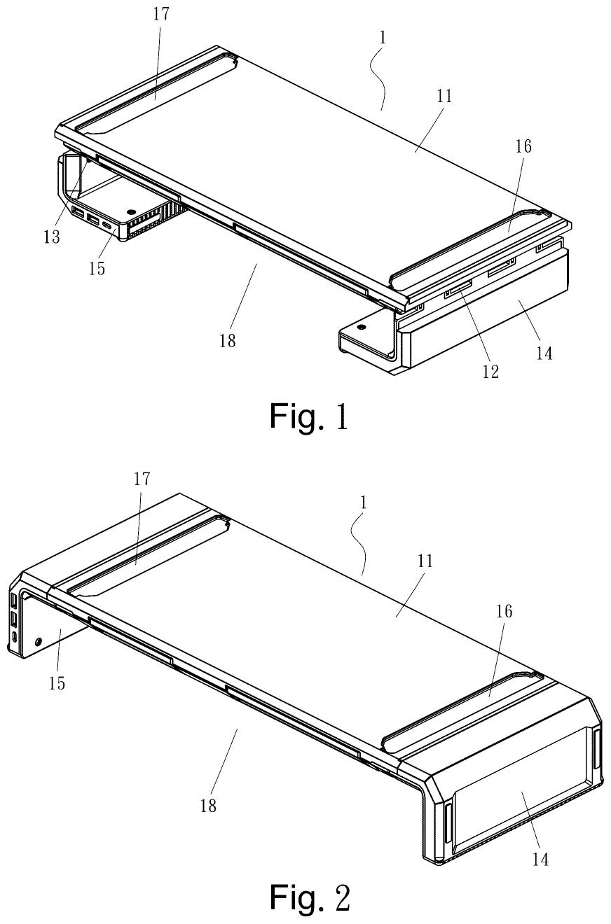

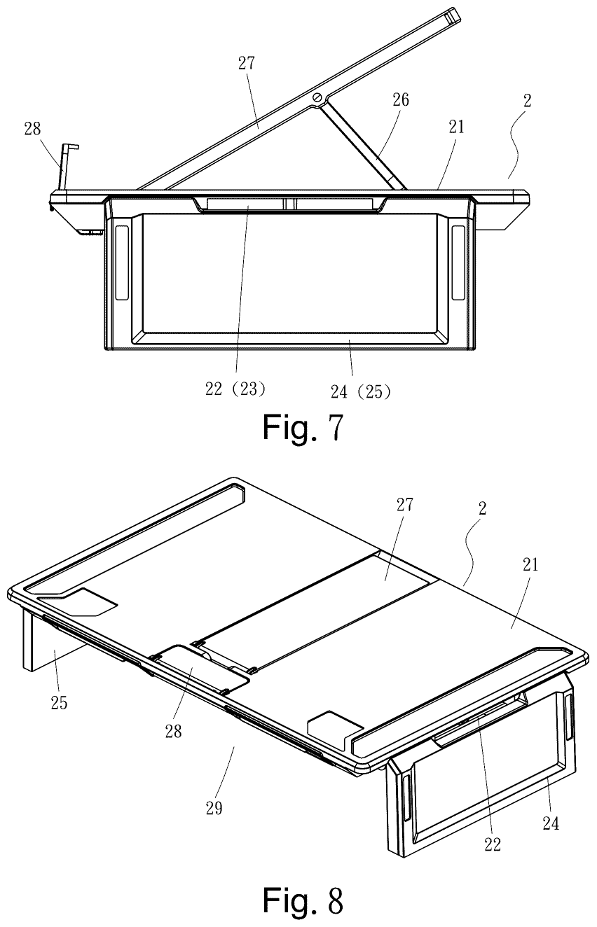

Referring to FIGS. 1 to 18, a rack apparatus for computers in accordance with the invention comprises a mother rack 1 and a daughter rack 2 as discussed in detail below.

The mother rack 1 includes a rectangular platform 11 on a top, a left L-shaped support 15 pivotably secured to a left side of the platform 11 by means of a left pivot 13, a right L-shaped support 14 pivotably secured to a right side of the platform 11 by means of a right pivot 12, a left groove 17 provided on a left side of the platform 11, a right groove 16 provided on a right side of the platform 11, and a space 18 under the platform 11. The left and right L-shaped supports 15, 14 can be folded by manipulating the left and right pins 13, 14 respectively (see FIG. 1). Alternatively, the left and right L-shaped supports 15, 14 can be unfolded to be ready to use by manipulating the left and right pins 13, 14 respectively (see FIG. 2).

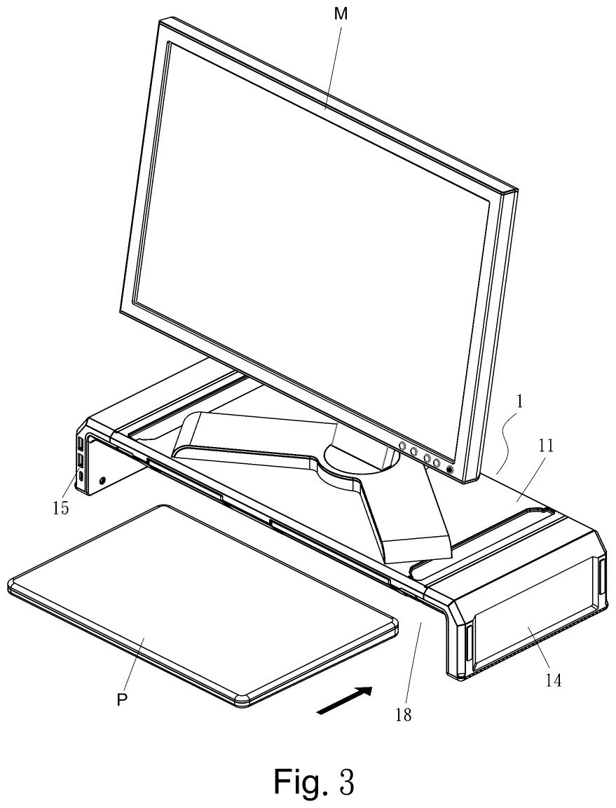

As shown in FIG. 3 specifically, the left and right L-shaped supports 15, 14 are unfolded, a computer display M is placed on the platform 11, and a tablet computer P is about to dispose in the space 18 in a use state of the mother rack 1.

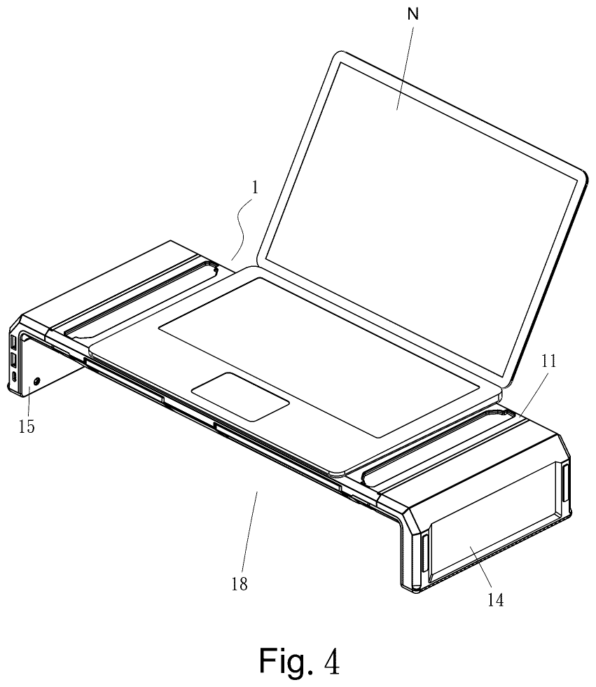

As shown in FIG. 4 specifically, the left and right L-shaped supports 15, 14 are unfolded and a laptop computer N is placed on the 11 platform in another use state of the mother rack 1.

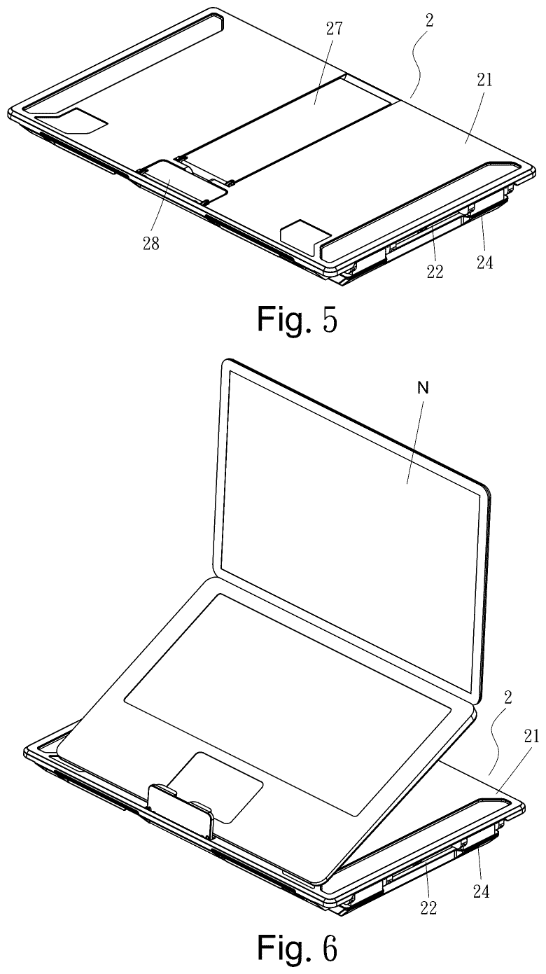

As shown in FIGS. 5, 7 and 8 specifically, the daughter rack 2 includes a rectangular platform 21 on a top, a left leg 25 pivotably secured to a left side of the platform 21 by means of a left pivot 23, a right leg 24 pivotably secured to a right side of the platform 21 by means of a right pivot 22, a pivotal limit member 28 provided on a central portion of a front end of the platform 21, a rectangular pivotal surface 27 provided rearward of the pivotal limit member 28, a rear support leg 26 having a first end pivotably secured to a back surface of the pivotal surface 27 and a second end pivotably secured to the platform 21, and a space 29 under the platform 21.

As shown in FIG. 6 specifically, the pivotal limit member 28 is fully pivoted to be substantially perpendicular to the platform 21, the pivotal surface 27 is pivoted to an inclined angle with respect to the platform 21, the left and right legs 25, 24 are folded, and a laptop computer N is placed on the pivotal surface 27 and has a front end stopped by the pivotal limit member 28 in a first use state of the daughter rack 2.

As shown in FIG. 8 specifically, the pivotal limit member 28 is pivoted to lie on the platform 21, the pivotal surface 27 is pivoted to lie on the platform 21, and the left and right legs 25, 24 are unfolded in a ready to use state of the daughter rack 2.

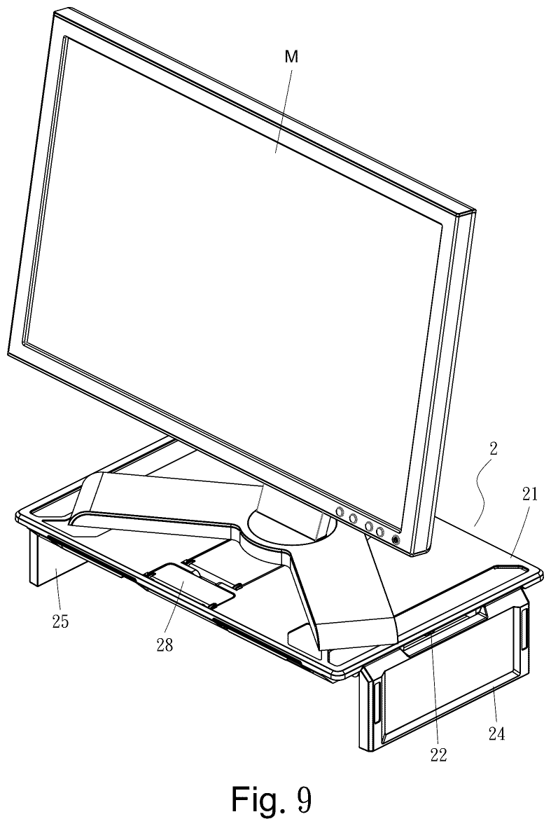

As shown in FIG. 9 specifically, the pivotal limit member 28 is pivoted to lie on the platform 21, the pivotal surface 27 is pivoted to lie on the platform 21, the left and right legs 25, 24 are unfolded, and a computer display M is placed on the platform 21 in second use state of the daughter rack 2.

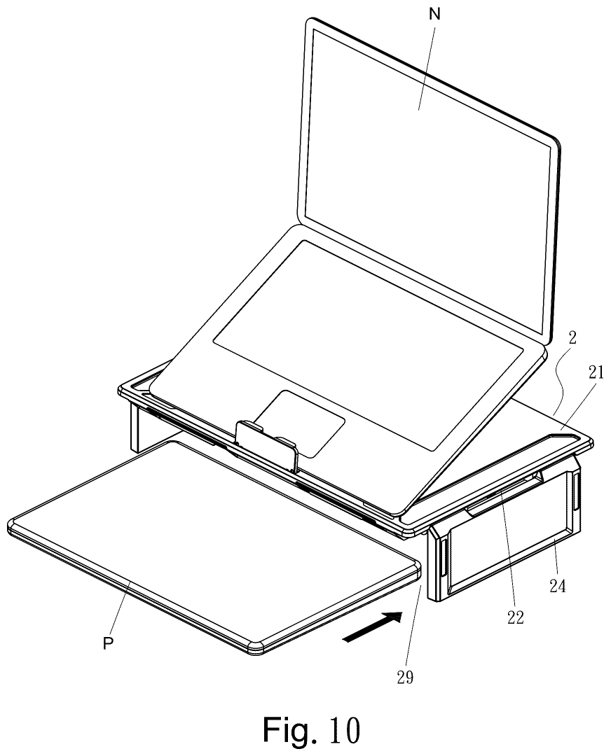

As shown in FIG. 10 specifically, the pivotal limit member 28 is fully pivoted to be substantially perpendicular to the platform 21, the pivotal surface 27 is pivoted to an inclined angle with respect to the platform 21, the left and right legs 25, 24 are unfolded, a laptop computer N is placed on the pivotal surface 27 and stopped by the pivotal limit member 28, and a tablet computer P is about to dispose in the space 29 in a third use state of the daughter rack 2.

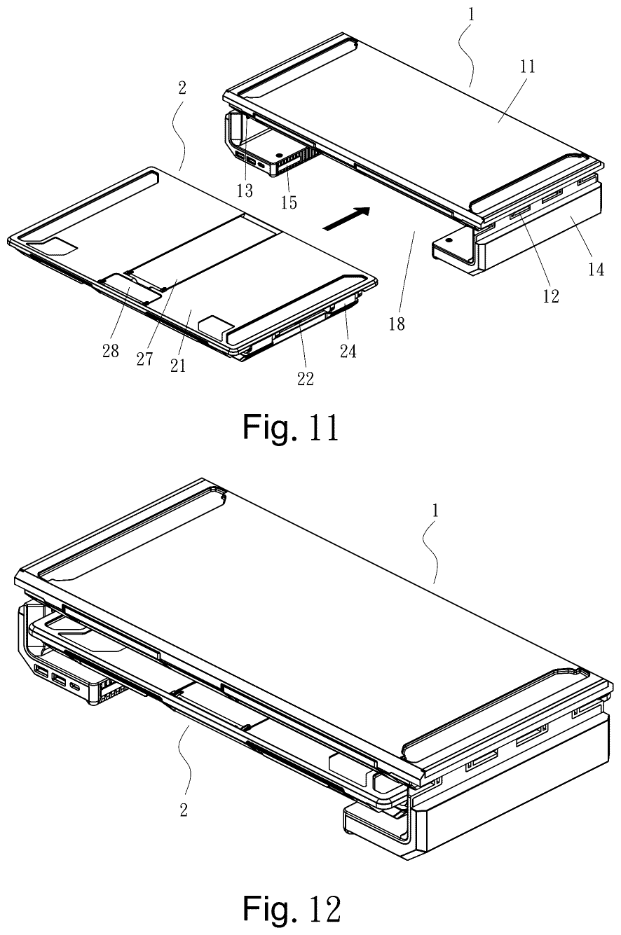

As shown in FIG. 11 specifically, the daughter rack 2 is about to dispose in the space 18 of the mother rack 1.

As shown in FIG. 12 specifically, the daughter rack 2 has been disposed in the mother rack 1.

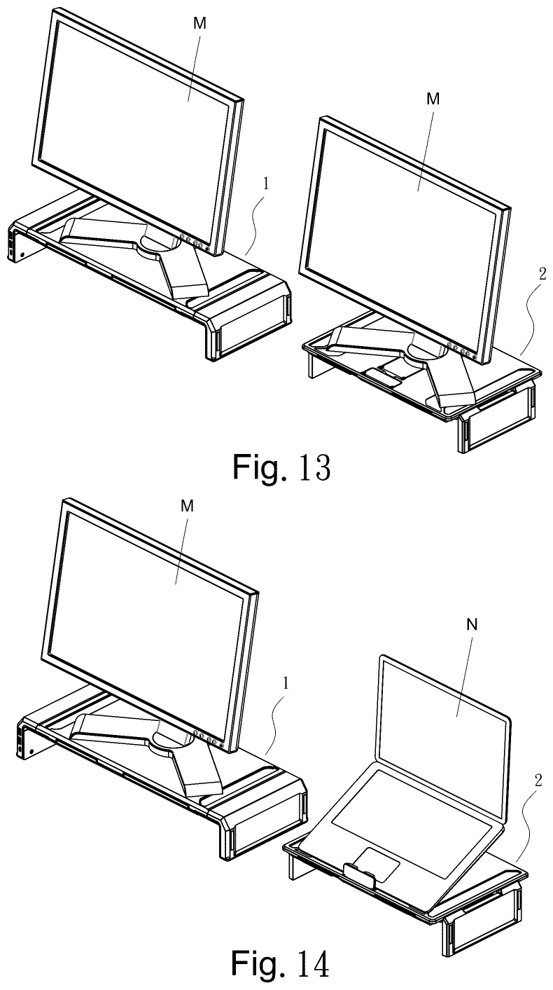

As shown in FIG. 13 specifically, a computer display M is placed on the mother rack 1 and another computer display M is placed on the daughter rack 2 respectively.

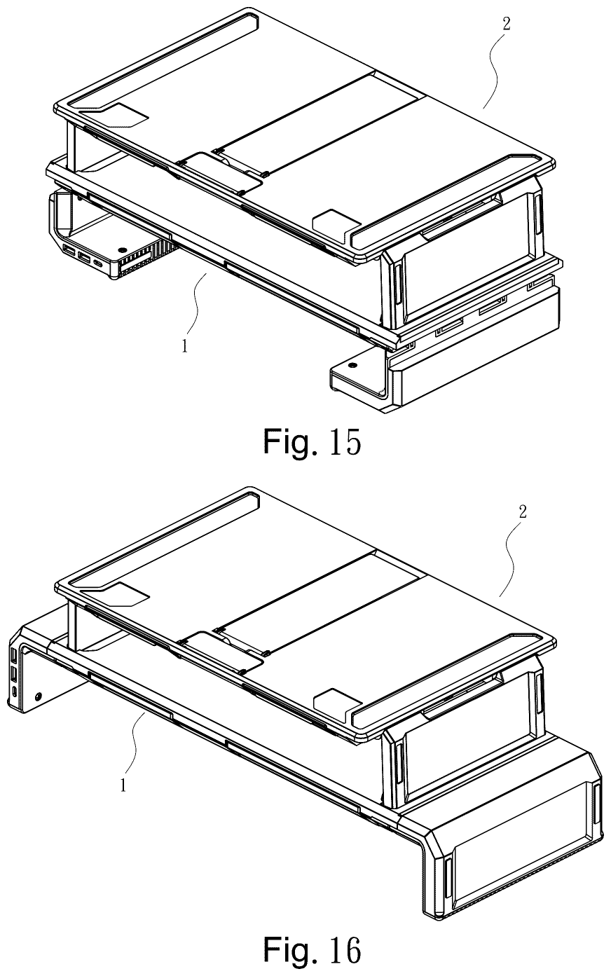

As shown in FIG. 14 specifically, a computer display M is placed on the mother rack 1 and a laptop computer N is placed on the daughter rack 2.

As shown in FIG. 15 specifically, the daughter rack 2 is placed on the mother rack 1 which is folded; the left leg 25 is fastened in the left groove 17; and the right leg 24 is fastened in the right groove 16.

As shown in FIG. 16 specifically, the daughter rack 2 is placed on the mother rack 1 which is unfolded.

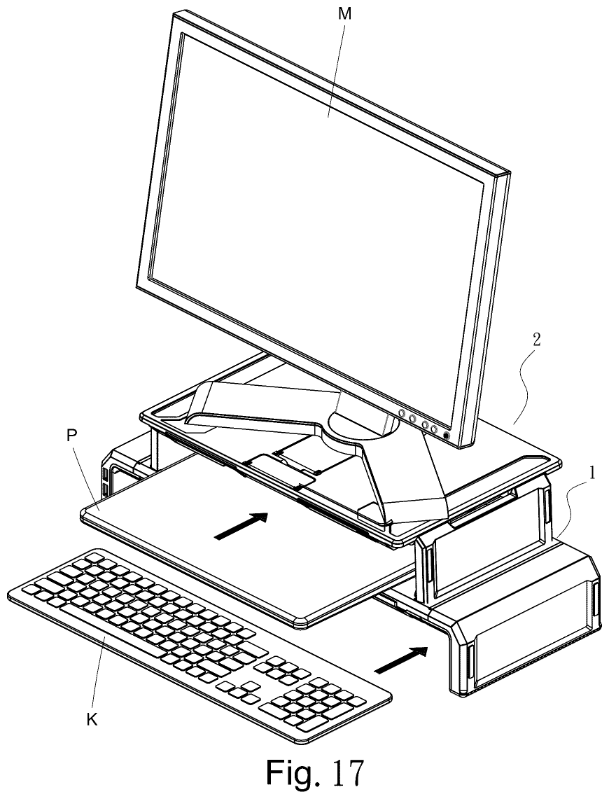

As shown in FIG. 17 specifically, a computer display M is placed on the daughter rack 2, a tablet computer P is about to dispose in the daughter rack 2, and a computer keyboard K is about to dispose in the mother rack 1.

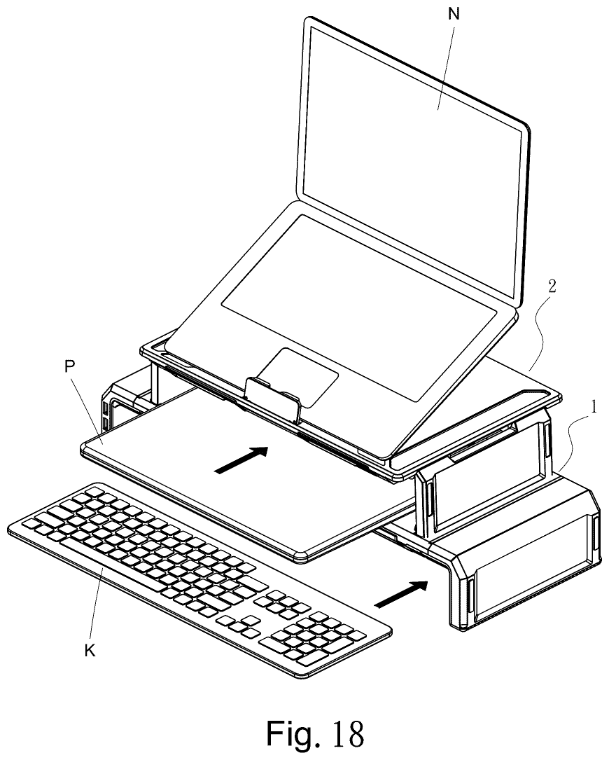

As shown in FIG. 18 specifically, a laptop computer N is placed on the daughter rack 2, a tablet computer P is about to dispose in the daughter rack 2, and a computer keyboard K is about to dispose in the mother rack 1.

While the invention has been described in terms of preferred embodiments, those skilled in the art will recognize that the invention can be practiced with modifications within the spirit and scope of the appended claims.

What is claimed is:

1. A rack apparatus, comprising:
a mother rack including a rectangular platform member on a top, a left L-shaped support pivotably secured to a left side of the platform member, a right L-shaped support pivotably secured to a right side of the platform member, a left groove disposed on a left side of the platform member, a right groove disposed on a right side of the platform member, and a space member disposed under the platform member; and
a daughter rack including a rectangular platform element on a top, a left leg pivotably secured to a left side of the platform element, a right leg pivotably secured to a right side of the platform element, a pivotal limit member disposed on a front end of the platform element, a pivotal surface disposed rearward of the pivotal limit member, a rear support leg having a first end pivotably secured to a back surface of the pivotal surface and a second end pivotably secured to the platform element, and a space element under the platform element;
wherein the left leg is configured to fasten in the left groove and the right leg is configured to fasten in the right groove respectively.
